(19) United States
(12) Patent Application Publication
(10) Pub. No.: US 2013/0272783 A1
(43) Pub. Date: Oct. 17, 2013

(54) ACTUATING LEVER WHICH CAN BE PIVOTED INTO A RECESS

(71) Applicant: Dieter Ramsauer, Schwelm (DE)

(72) Inventor: Dieter Ramsauer, Schwelm (DE)

(21) Appl. No.: 13/821,049

(22) PCT Filed: Aug. 24, 2011
(86) PCT No.: PCT/EP11/04246

§ 371 Date: Mar. 22, 2013

(30) Foreign Application Priority Data
Sep. 6, 2010 (DE) 20 2010 012 226.0

(51) Int. Cl. F16B 5/06

(52) U.S. Cl. CPC F16B 5/06
USPC 403/330

(57) ABSTRACT

A fastening device having a fastening clamp which is shaped from springing flat material for fastening a perforated first thin wall to a second thin wall or carrier wall with a corresponding perforation. The fastening clamp comprises a body region which proceeds from the neck region and has two opposing step-back surfaces of the flat material which are formed by bending. The step-back surfaces are springingly supported on, the hole face, the edge or the edge face of the perforation of the second thin wall. According to the invention, the two step-back surfaces are formed by two V-shaped spring portions which project beyond the thin walls, and the perforation for receiving the fastening clamp comprises two adjacent rectangular holes which are separated by a web.

The present application claims priority from PCT Patent Application No. PCT/EP2011/004246 filed on Aug. 24, 2011, which claims priority from German Patent Application No. DE 20 2010 012 226.0 Filed on Sep. 6, 2010, the disclosures of which are incorporated herein by reference in their entirety.

### FIELD OF THE INVENTION

The invention is directed to a fastening device having a fastening clamp formed of one or more parts and shaped from springing flat material for fastening a perforated first thin wall or other thin-walled structural component part to a thin-walled second thin wall or carrier provided with a corresponding perforation, wherein the fastening clamp comprises a head region which, in the assembled state of the clamp, contacts the one side of the one thin wall, which side is remote of the other thin wall, a neck region which proceeds from the body region and projects through the perforations of the two thin walls in the assembled state of the clamp, and a body region which, in the assembled state, proceeding from the neck region, projects beyond the other side of the other thin wall by two opposing step-back surfaces of the flat material which are formed by bending, wherein the step-back surfaces are springingly supported on the hole face, the edge or the edge face of the perforation of the carrier.

It is noted that citation or identification of any document in this application is not an admission that such document is available as prior art to the present invention.

A fastening device of the type mentioned above is known from the Internet publication of A. Raymond GmbH & Co. KG, Teichstr. 57, 79539 Lörrach, see product group CAA, component D, “spring clamps”.

It is noted that in this disclosure and particularly in the claims and/or paragraphs, terms such as “comprises”, “comprised”, “comprising” and the like can have the meaning attributed to it in U.S. patent law; e.g., they can mean “includes”, “included”, “including”, and the like; and that terms such as “consisting essentially of” and “consists essentially of” have the meaning ascribed to them in U.S. patent law, e.g., they allow for elements not explicitly recited, but exclude elements that are found in the prior art or that affect a basic or novel characteristic of the invention.

It is further noted that the invention does not intend to encompass within the scope of the invention any previously disclosed product, process of making the product or method of using the product, which meets the written description and enablement requirements of the USPTO (35 U.S.C. 112, first paragraph) or the EPO (Article 83 of the EPC), such that applicant(s) reserve the right to disclaim, and hereby disclose a disclaimer of, any previously described product, method of making the product, or process of using the product.

### SUMMARY OF THE INVENTION

It is the object of the invention to provide another design of a spring clamp of the kind mentioned above which is used, for example, in switch cabinets, guard rails, solar installations, automobile construction, etc. to detachably fasten a perforated thin wall to a perforated carrier in order to replace a rigid screw connection by a clamp connection which can be assembled quickly and which is flexible but durable. The spring clamp can be used in automobile construction, in guard rail construction, in solar cell construction and in other fields.

The above-stated object is met in that the two step-back surfaces are formed by two V-shaped spring portions which project beyond the thin walls, and the perforation comprises two adjacent rectangular holes which are separated by a web for receiving the fastening clamp.

A lasting torsional strength and a very strong connection under shear stress are achieved by means of the multiple perforation, particularly by means of the two holes.

According to a further development of the invention, the fastening clamp comprises two legs or branches remote of one another and two branches facing one another; the two branches remote of one another form at the free ends thereof the step-back surface on the one hand and, at a tight angle thereto, a stop face on the other hand for abutting at the hole face of the one rectangle side of the rectangular perforation in the thin wall and the thin-walled wall carrier.

The twofold perforation affords the advantage that the walls which are connected to one another allow displacements because the perforation can be formed of smaller holes which automatically result in reduced bet dab of the wall portions relative to one other. This additional displaceability is limited to half of the extension of the perforation in the direction of movement. Counter to the spring force, the movements perpendicular thereto are allowed only through play, but apart from this there is no possibility of movement in this direction.

According to a further embodiment form of the invention, the two branches facing one another are joined to one another at their free ends and in this connecting region form a head which forms the head region. By forming this head, the arrangement is made even stiffer in the sliding direction and in the direction of spring movement.

According to yet another embodiment form, the mutually facing branches together with the head have a mushroom shape in cross section. This allows the fastening clamp to be pressed into the perforation.

When the head forms a void at its underside and two edges of the head rest on the thin wall in the assembled state, this affords space for the movement of the spring legs during the assembly process and also allows larger clamping areas to be realized with the same clamp (tolerance compensation).

The edge of the head can be bent in a curve having a radius of curvature such that the top of the head can form a planar surface. On the other hand, the top of the head can also form a rounded surface either with a rounded edge cross section or with a sharply bent edge cross section. The head shape affects the appearance as well as handling during assembly and disassembly.

Projections extending away from the mutually facing branches laterally perpendicular to the branch plane can be provided in the neck region, the lateral extension of which completely fills, or only partially fills, the respectively contacting side wall of the perforation and can either receive therebetween and guide the free end of the branches remote of one another or forms an abutment for the stop faces.

The shear strength is increased by providing two additional slots for the perforation perpendicular to the longitudinal extension of the rectangular holes near the ends thereof, these two additional slots being penetrated by projections proceeding from the planar surface of the head of the fastening spring when assembled; only the play determined by the penetrating projections or branches need be taken into account. The branches of the fastening clamp can have a width that is smaller in direction of the connecting web thereof and is virtually conical.

### BRIEF DESCRIPTION OF THE DRAWINGS

FIG. 1A shows a perspective view of a fastening clamp designed according to the invention and two perforated thin wails which can be fastened to one another, before assembly;

FIG. 1B shows the one assembled thin wall with clamp inserted through it;

FIG. 1C shows the thin walls fastened to one another by the clamp, after the assembly process;

FIG. 1D shows an axial section through the fastening clamp and through the two thin walls;

FIG. 1E shows the fastening clamp in extracted state;

FIG. 1F shows a front view of the fastening clamp of FIG. 1E;

FIG. 1G shows a perspective view of the fastening damp of FIGS. 1A to 1F;

FIGS. 2A, 2B and 2C show views corresponding to FIGS. 1A, 1B and 1C with another embodiment form with additional means for preventing displacement of the thin walls relative to one another;

FIG. 2D shows a side view of the clamp according to FIGS. 2A to 2C;

FIG. 2E shows a front view of the clamp according to FIGS. 2A to 2C;

FIG. 2F shows a perspective view of the clamp according to FIGS. 2A to 2C;

FIG. 3 shows an axial sectional view of an embodiment form with modified head;

FIG. 4 shows a sectional view through an embodiment form with further modified head;

FIG. 5A shows another configuration of the embodiment form according to FIG. 4;

FIG. 5B shows a section along the axis of the arrangement of FIG. 5A; and

FIGS. 6A and 6B show views similar to those in FIGS. 5A and 5B of yet another embodiment form of the invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

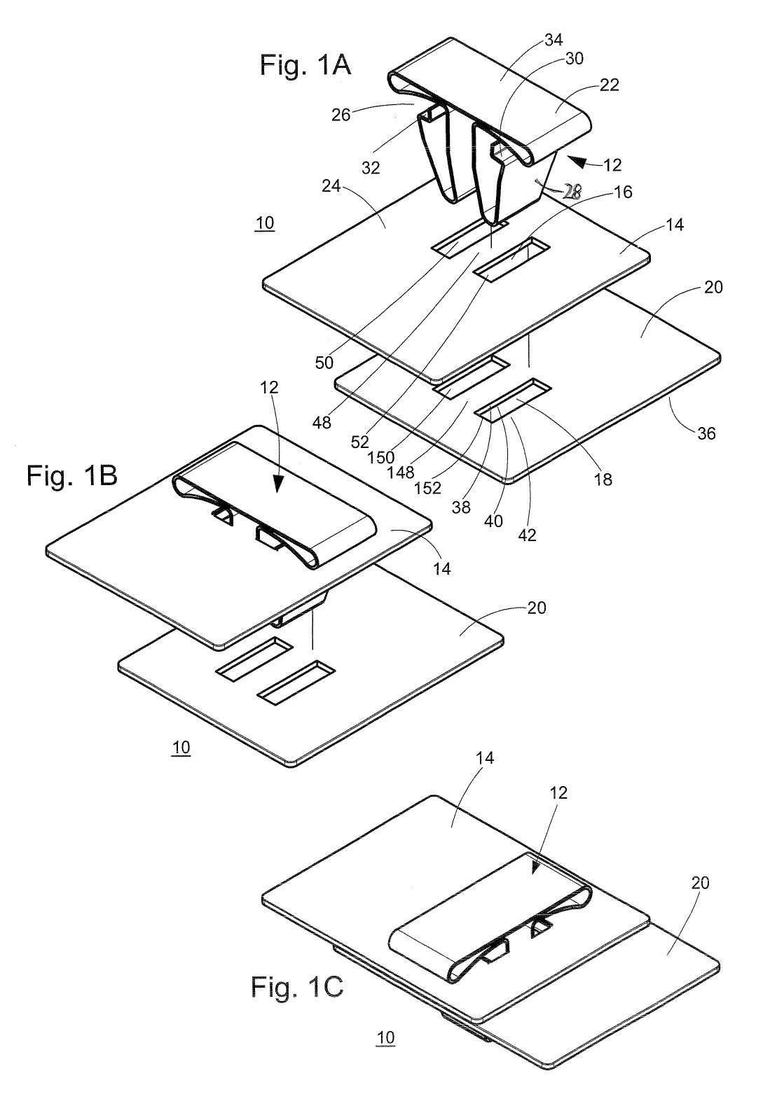

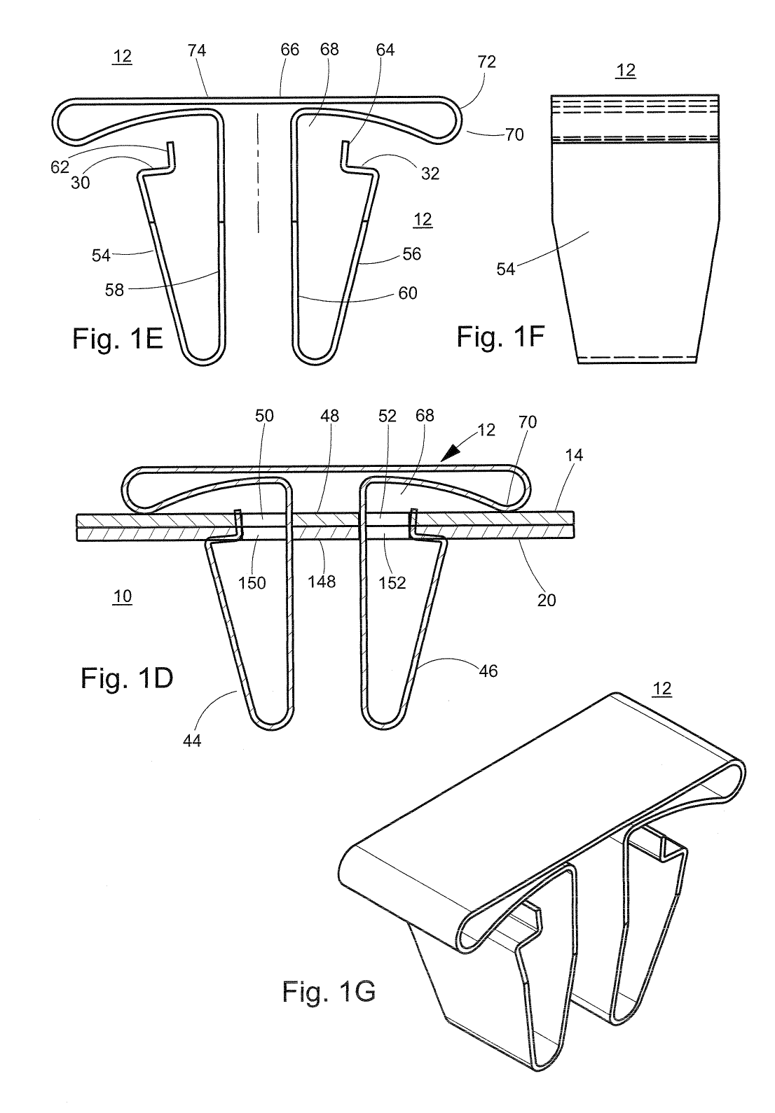

FIG. 1A shows a perspective view of an embodiment form of a fastening device 10 having a fastening clamp 12 which is shaped from springing flat material for fastening a perforated (see reference numeral 16) thin wall 14 or other thin-walled structural component part to a thin-walled carrier 20 which is provided with a corresponding perforation 18. The fastening clamp 12 comprises a head region 22 which contacts the one side 14 of the side 24 of the one thin will 14 remote of the other 20 thin wall in the assembled state of the fastening clamp, a neck region 26 which extends from the head region 22 through the perforations 16, 18 of the two thin walls 14, 20 in the assembled state of the fastening clamp 12, and a body region 28 which, in the assembled state, starting from the neck region 26 projects beyond the other side 36 of the other thin wall 20 by two opposing step-back surfaces 30, 32 of the flat material 34 winch are formed by bending. The step-back surfaces 30, 32 are springingly supported, see FIG. 1A, on the hole face 38, the edge 40 or the edge face 42 of the perforation 18 of the thin wall 20 forming the carrier. FIG. 1A also shows a perspective view of the situation before fastening by inserting the fastening clamp into the two perforations 16, 18 of the thin walls 14, 20.

According to the invention, the two step-back surfaces 30, 32 are formed by two V-shaped parts 44, 46, and the perforation 16, 18 for receiving the fastening clamp 12 includes two rectangular holes 50, 52 which are disposed side by side and separated by a web 48.

As is particularly clearly apparent from FIGS. 1C and 1D, the fastening clamp 12 comprises two legs or branches 54, 56 remote of one another and two branches 58, 60 facing one another. At their free ends, the two branches 54, 56 remote of one another have the step-back surface 30 and 32, respectively, on the one hand and, at a right angle to the latter, a stop face 62 and 64, respectively, on the other hand for abutting at the hole face 38 of the one rectangle side of the rectangular perforation in the thin wall and the thin-walled wall carrier 14, 20.

The two branches 58, 60 of the fastening clamp 12 which face one another are joined at their free ends and in this connecting region form a head which forms the head region. As can be further seen from the figures, the branches 58, 60 which face one another, together with the head 66, have a mushroom shape in cross section.

The head 66 forms a void 68 at its underside. The two edges 70 of the head 66 rest on the thin wall 14 in the assembled state of the fastening clamp.

In the embodiment form according to FIGS. 1A to 1G, the edge of the head is bent into a curve 72 having a radius of curvature such that the top of the head 66 forms a planar surface.

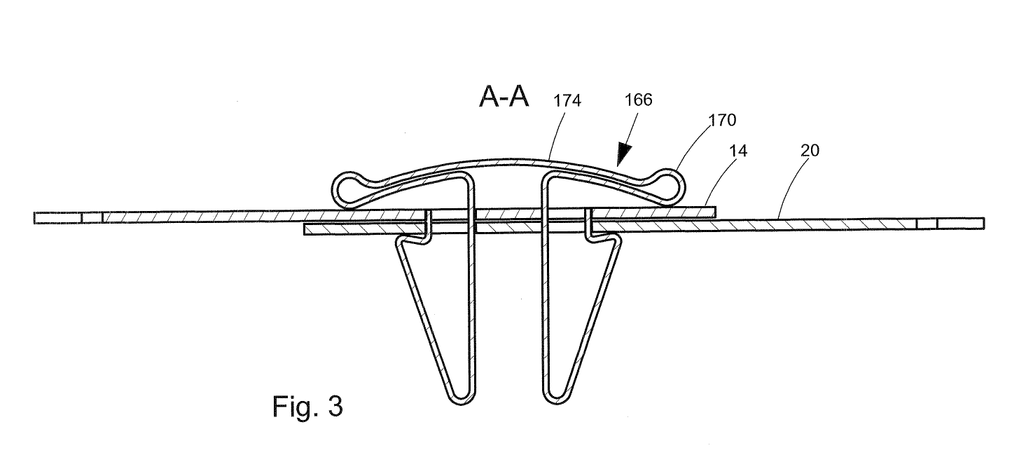

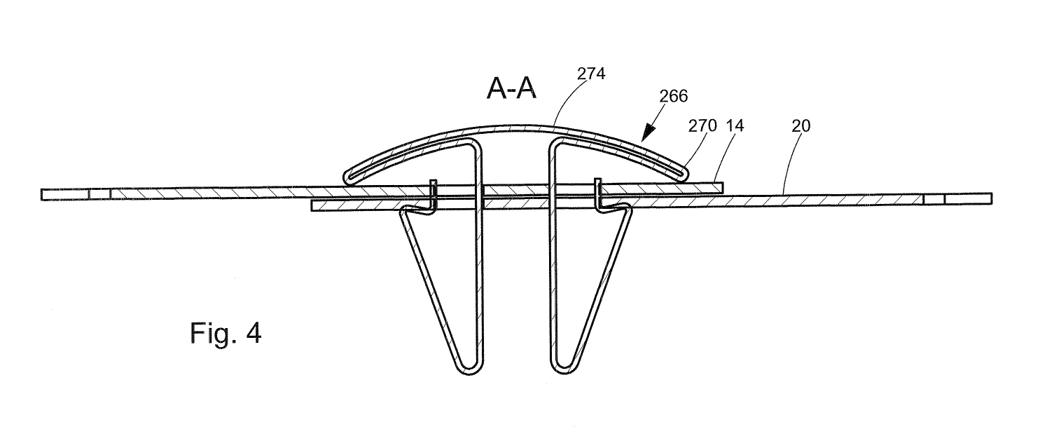

In contrast, the embodiment form according to FIG. 3 is configured in such a way that the top 174 of the head 166 forms a rounded surface 174. A sharply bent edge cross section—see head 266 with top 274—can also be used instead of the round edge cross section according to FIG. 3.

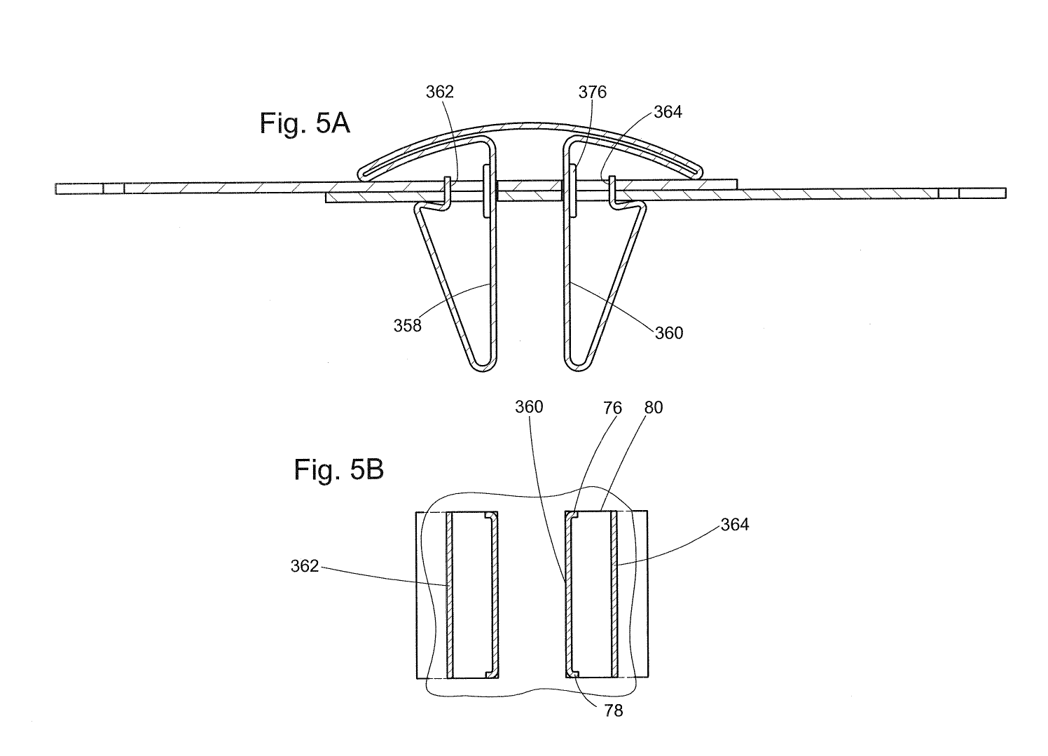

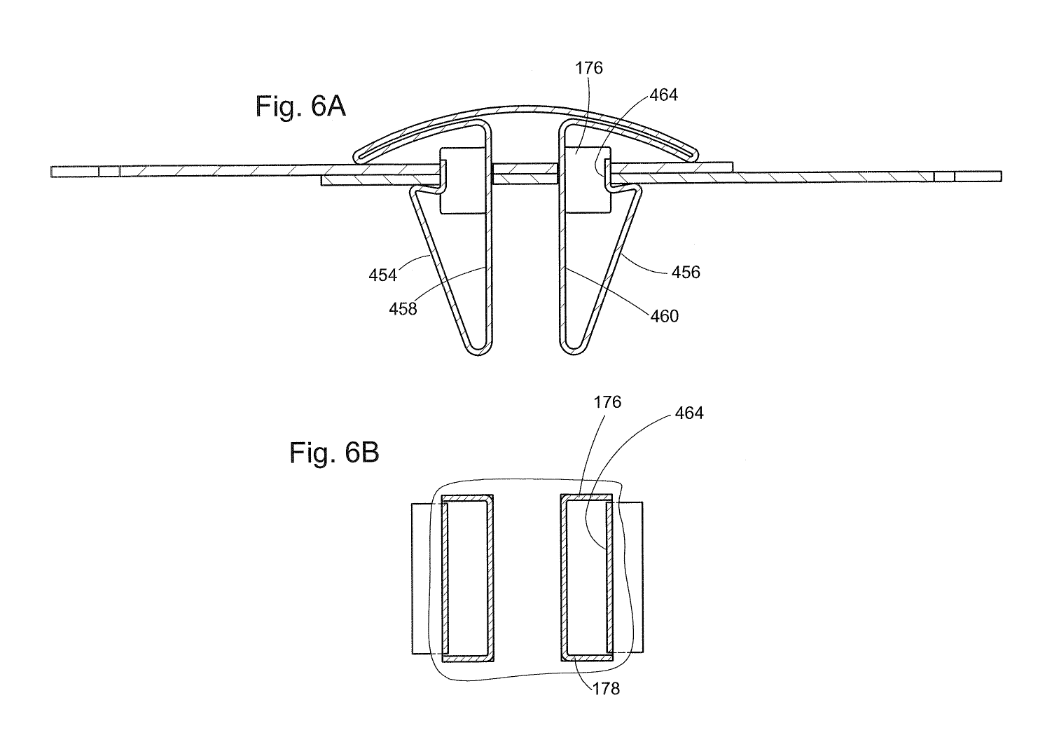

In all three embodiment forms, the edge 70, 170, 270 of the head presses on the thin wall 14. In the embodiment form shown in FIGS. 5A and 5B, projections 76, 78 extending away from the mutually facing branches 360, 358 laterally perpendicular to the branch plane are provided in the neck region, and the lateral extension fills the respectively contacting side wall 80 only partially (FIGS. 5A and 5B) or completely (FIGS. 6A and 6B); the free end of the branches 358, 360 and 458, 460, respectively, increases the shear forces that can be tolerated.

In the embodiment form according to FIGS. 5A, 5B, the projections 76, 80 form an abutment for the stop faces 62, 64.

In the embodiment form shown in FIGS. 6A and 6B, the projection 176 completely fills the perforation so that the free ends of the branches 454, 456 remote of one another are received and guided therebetween.

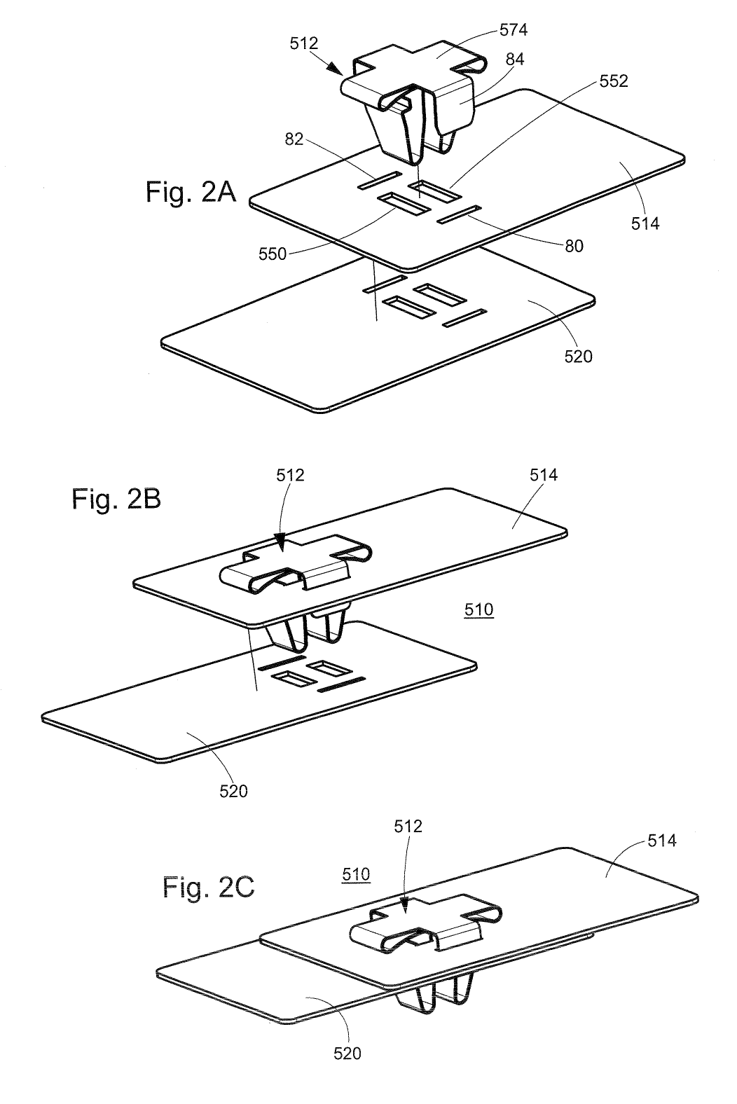

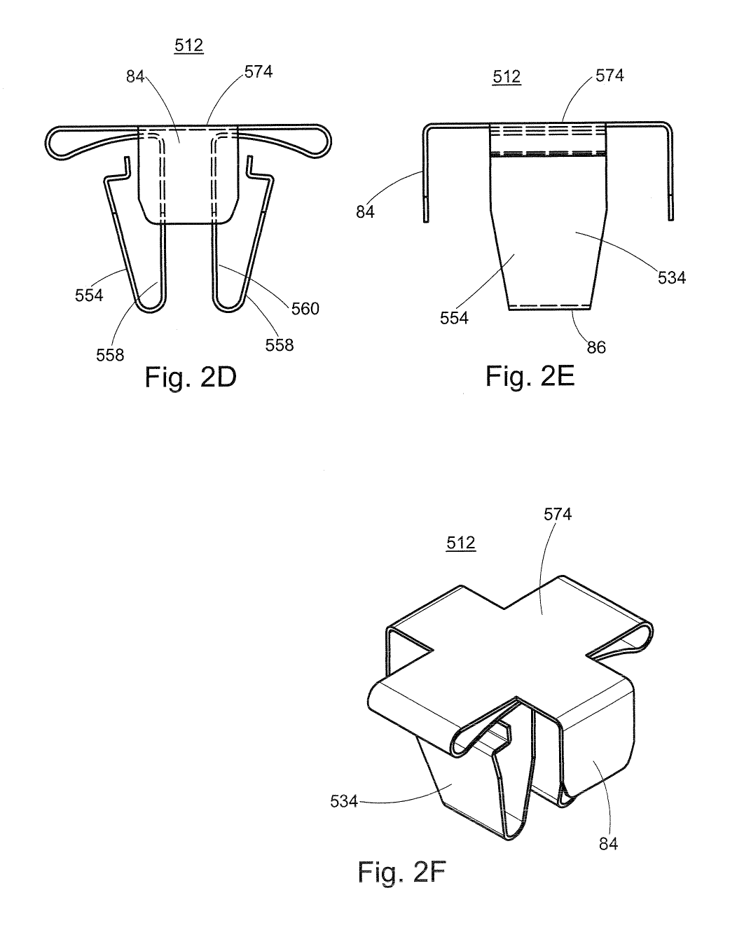

As is shown in the embodiment form according to FIGS. 2A to 2F, the perforation can have two additional slots 80, 82 perpendicular to the longitudinal extension of the rectangular holes 250, 252 near the ends thereof, and projections 84 proceeding from the planar surface 74 of the head of the fastening spring penetrate into these two additional slots 80, 82 during assembly and are then bent perpendicularly.

This further increases the shear strength of the arrangement both in direction of the slots and perpendicular thereto.

To facilitate insertion of the fastening clamp into perforation 52, 55, the branches 554, 534 can be constructed conically, see FIG. 2E; i.e., they are provided with a width which becomes smaller in direction of the connecting web 86 thereof.

FIGS. 2A, 2B and 2C show the arrangement during assembly. In FIG. 2A, the two thin walls and the fastening clamp 512 are still separated. In FIG. 2B, the fastening clamp 512 is inserted into the perforation 80 of thin wall 514. When the second wall 520 is pressed in see FIG. 2C, all three structural component parts are connected to one another.

### COMMERCIAL APPLICABILITY

The invention is commercially applicable in switch cabinet construction.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

### LIST OF REFERENCE NUMERALS

10 fastening device
12 fastening clamp
14 thin wall
16 perforation, thin wall
18 perforation, carrier
20 carrier, other thin wall
22 head region
24 one side
26 neck region
28 body region
30 step-back surface
32 step-back surface
34 flat material
36 other side
38 hole face
40 edge
42 edge surface
44 V-shaped part
46 V-shaped part
48, 148 web
50, 151 rectangular hole
52, 152 rectangular hole
54 far-side branch
56 far-side branch
58 near-side branch
60 near-side branch
62 stop face
64 stop face
66, 166 head
68 void
70 head edge
72 rounded portion
74, 174 top of head
76 projection
78 projection
80 side wall of the perforation
82 slot
84 projections
86 connecting web

1. Fastening device (10) having a fastening clamp (12) which is shaped from springing flat material for fastening a perforated first thin wall (14) or other thin-walled structural component part to a second thin wall or carrier wall with a corresponding perforation, wherein the fastening clamp (12) comprises a head region (22) which contacts the one side (24) of the one thin wall (14), which side (24) is remote of the other thin wall (20), in the assembled state of the clamp, a neck region (26) which proceeds from the head region (22) and projects through the perforations (16, 18) of the two thin walls (14, 20) in the assembled state of the fastening clamp (12), and a body region (28) which in the assembled state of the fastening clamp (12) starting from the neck region (26) projects beyond the other side (36) of the other thin wall (20) by two opposing step-back surfaces (30, 32) of the flat material (34) which are formed by bending, wherein the step-back surfaces (30, 32) are springingly supported on the hole face (38), the edge (40) or the edge face (42) of the perforation of the second thin wall (20), characterized in that the two step-back surfaces (30, 32) are formed by two V-shaped spring portions (44, 46) which project beyond the thin walls, and the perforation for receiving the fastening damp (12) comprises two adjacent rectangular holes (50, 52) which are separated by a web (48).

2. Fastening device according to claim 1, characterized in that the fastening clamp (12) comprises two legs or branches (54, 56) remote of one another and two branches (58, 60) facing one another, and in that the two branches (54, 56) remote of one another form at the free ends thereof the step-back surface (30, 32) on the one hand and, at a right angle thereto, a stop face (62, 64) on the other hand for abutting at the hole face (38) of the one rectangle side of the rectangular perforation (50, 52) in the thin wall and the thin-walled wall carrier (14, 20).

3. Fastening device according to claim 2, characterized in that the two branches (58, 60) facing one another are joined to one another at their free ends and in this connecting region form a head (66) which forms the head region.

4. Fastening device according to claim 3, characterized in that the mutually facing branches (58, 60) together with the head (66) have a mushroom shape in cross section.

5. Fastening device according to claim 4, characterized in that the head (66) forms a void (68) at its underside and two edges (70) of the head (66) rest on the first thin wall (14) in the assembled state.

6. Fastening device according to claim 5, characterized in that the edge (70) of the head (66) is bent in a curve (72) having a radius of curvature such that the top (74) of the head (66) can form a planar surface.

7. Fastening device according to claim 5, characterized in that the top of the head forms a rounded surface either with rounded edge cross section or with sharply bent edge cross section.

8. Fastening device according to claim 1, characterized in that projections (76, 78) extending away from the mutually facing branches (58, 60) laterally perpendicular to the branch plane are provided in the neck region (26), with a lateral extension which completely or only partially fills, the respective contacting side wall of the perforation and which either receive therebetween and guide the free end of the branches (54, 56) remote of one another or form an abutment for the stop Faces (62, 64).

9. Fastening device according to claim 6, characterized in that two additional slots (82) are provided for the perforation perpendicular to the longitudinal extension of the rectangular holes (50, 52) near the ends thereof, these two additional slots (82) being penetrated by projections (84) proceeding from the planar surface (74) of the head (66) of the fastening spring when assembled.

10. Fastening device according to one of claims 1 to 9, characterized in that the branches of the fastening damp have a width that is smaller in direction of the connecting web (86) thereof and is virtually conical.
